(19) United States
(12) Patent Application Publication
(10) Pub. No.: US 2010/0239848 A1
(43) Pub. Date: Sep. 23, 2010

(54) Film and Prepreg with Nanoparticles, Processes of Making Thereof, and Reinforced Component Made Therewith

(76) Inventor: Jerome Le Corvec, Ottawa (CA)

Correspondence Address: VEDDER PRICE P.C., 222 N. LASALLE STREET, CHICAGO, IL, 60601, US

(21) Appl. No.: 12/408,594

(22) Filed: Mar. 20, 2009

(51) Int. Cl. B32B 5/16; B32B 27/38; B05D 3/00; B05C 1/08; B05C 11/00; B32B 37/14

(52) U.S. Cl. 428/323; 428/413; 427/398.1; 427/9; 118/258; 118/712; 156/307.7; 977/742; 977/773

(57) ABSTRACT

The present disclosure generally relates to a single-layer film and a prepreg, an industrial process of making thereof, and a reinforced component made therewith, and more specifically, to films with uniformly dispersed nanoparticles in a matrix with thermoset resin layered on a release film for storage, an industrial process for making the films, and reinforced components layered and reinforced using either the single-layer film or the prepreg.

### FIELD OF THE DISCLOSURE

The present disclosure generally relates to a layer film and a prepreg, an industrial process of making thereof.

### BACKGROUND

Thermosetting resins, often known simply as “thermosets,” are light polymer materials that irreversibly cure into a fixed form. In order to obtain the desired shape, the malleable resin is mixed with a substance that chemically reacts with the resin and molded into a form. The chemical reaction, generally called hardening, can be initiated and accelerated by applying heat, irradiation, or even by using electron beam processing. While polymers are generally stable and have low thermal conductivity and low density, they also possess inherent problems such as a vulnerability to aging, relatively low breakdown temperatures, and weak resistance to mechanical loads when compared with ceramics or metals. In the case of epoxy, a cure generally above 200° F. is conducted to initiate the chemical reaction.

Material sciences are constantly seeking thermoset resins and resin compounds with better performance. For example, glass and carbon fibers can be used in a matrix of thermoset resin to create a carbon fiber reinforced plastic (CFRP) or a glass fiber reinforced plastic (GFRP) as a strong, light composite material. These fibers can be woven into tissues and layered in the thermoset matrix to improve the overall properties of a material. These composite materials have many commercial applications; mainly in the aerospace, automotive, naval construction, and sporting goods industry. The composite materials also have commercial applications in high endurance and high impact sports. Thermoset resin compounds are also used in smaller consumer goods such as electronic equipment, guitar strings, golf clubs, and the like.

Composites are made of at least two different materials, often combining a polymer matrix and a fiber. The properties of the finished composite are dominated by the contribution of the fiber reinforcement but the resin matrix plays an important role inherent properties of the each of the components. One method of producing a carbon-epoxy part is to successively layer sheets of carbon fiber reinforcements into a mold having the shape of the final part. The alignment and weave of the reinforcement fibers is chosen to optimize the properties of the material. A thermoset resin and a curing agent are added and the mixture is cured. Another method of producing such parts is to simply lay up a fiber reinforcement pre-impregnated with resin onto the surface of a mould. These preimpregnated reinforcements are commonly known as “prepregs”. Generally vacuum or pressure is applied during heating the mould. For example, the paddle of a rowing instrument can either be molded into a composite made of epoxy and carbon fibers or can be locally reinforced by wrapping a prepreg around a wooden paddle and curing the appropriate portion. FIG. 2 illustrates a device from the prior art such as a hockey stick.

Another method of reinforcing a thermoset resin matrix is to add small, detached particles into the matrix. For example Carbon Nanotubes (CNTs) are small cylindrical objects with a diameter in the nanoscale that can have a length to diameter ratio of one thousand to one, or even higher. Those carbon molecules show extraordinary strength and unique electrical and heat conduction properties. Because of their geometry and high surface area, airborne nanotubes, as well as nanoparticles in general, are suspected to cause adverse effects on human health and the environment. Hence, there is a need for an improved film, process of making the film, and product made from the film that allow safe handling of such ultrafine particles.

Ideally, CNTs consist of rolled-up sheets of hexagonally arranged carbon atoms. Each carbon atom is bonded to three other carbon atoms via sp²- and sp³-bonds, which provides these structures a unique strength. Like other ultrafine particles, carbon nanotubes tend to clump together, thus forming aggregates held together by Van der Waals forces. The presence of big aggregates in a resin or composite leads to a decrease in the mechanical properties of the material. Therefore, a homogeneous dispersion of the particles within a matrix is very important. Due to the high number of Van der Waals forces between aggregated CNTs, a homogeneous dispersion is difficult to obtain. In addition, even well dispersed ultrafine particles tend to re-aggregate and to settle down after a certain period of time when no energy is added to the system.

Advantages gained by incorporating CNTs into a matrix can be quickly offset by a non-uniform distribution of the particles in the matrix. If the CNTs concentration varies ultimately over a surface or a volume in a reinforced component, the component will then present zones of strength and weakness, depending upon the concentration of the CNTs. Loosely aggregated particles in a reinforced body act only as a local strain concentrator and ultimately weaken the entire structure. For this reason, the homogeneous distribution of the CNTs in the matrix is crucial.

Reinforced components within the scope of this disclosure are meant to include any suitable commercial applications, for example in the aerospace, automotive, naval construction, and sporting goods industry. For example, reinforced components can have commercial applications in high endurance and high impact sports such as boat shells, bike frames, hockey sticks, etc.

The Nanoledge® Incorporation markets thermoset resins loaded with carbon nanotubes as part of the INNOVIUM innovative resin solution. These resins-CNT mixtures are sold as concentrates and are then used as a base to obtain a reinforced piece. In a process shown in prior art FIG. 1, a mixer may be used to mix a small percentage of CNTs in a thermoset resin. As the mixer operates, the heat of the device or additional heat is used to process the mixture. The resin may be cooled prior to be further mixed in a subsequent step with additional elements such as more thermoset resin, curing agents, or hardener to create a final product with the desired curing properties and texture. The resulting paste, while offering advantages over the prior art, must then be further heated, mixed, and cooled to serve as the base of reinforced components. CNTs in such a premix paste occupy a three-dimensional volume and the cylinders are not aligned specifically along a principal direction.

U.S. Patent Publication No. 2006/0166003 to Khabashesku describes a different method of mixing CNTs into a three-dimensional epoxy matrix by a chemical process called chemical moieties as functional groups attached to the sidewall and/or the end cap of the CNTs during the curing process. What is needed is an improved method and process of making a stable CNT-based thermoset matrix that can be used to produce reinforced components without chemical processes or intermediate phases in the production processes that allows the diffusion of CNT in the matrix to revert back to a less efficient configuration.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 is an illustration of a process for making a master batch of CNT-based resins of the prior art.

FIG. 2 is an illustration of a reinforced component from the prior art where a carbon fiber tape is used to reinforce a portion of the device.

FIG. 3 is a functional diagram of a process for making a film covered by two layers of release paper according to an embodiment of the present disclosure.

FIG. 4 is a functional diagram of a process for making a prepreg covered by two layers of release paper according to an embodiment of the present disclosure.

FIG. 5 is a close-up view of the prepreg forming process step from FIG. 4 according to an embodiment of the present disclosure.

FIG. 6 is a cross-sectional view of FIG. 5 of the film over a layer of release paper according as a first phase of the process of making the film or the prepreg as shown in FIGS. 3 and 4.

FIG. 7 is a cross-sectional view of FIG. 5 of the film and reinforced woven fabric over a layer of release paper as a subsequent phase of the process of making the prepreg as shown in FIG. 4.

FIG. 8 is a cross-sectional view of FIG. 5 of the film and reinforced woven fabric over a layer of release paper once pressure and temperature has been applied as a subsequent phase of the process of making the prepreg as shown in FIG. 4.

FIG. 9 is an illustration of a reinforced component with a surface film or prepreg made in accordance with the process shown as FIGS. 3 and 4 according to an embodiment of the present disclosure.

FIG. 10 is an illustration of a reinforced component wrapped in a film or prepreg made in accordance with the process shown as FIGS. 3 and 4 according to an embodiment of the present disclosure.

FIG. 11 is an illustration of a second reinforced component with a surface film or prepreg made in accordance with the process shown as FIGS. 3 and 4 according to an embodiment of the present disclosure.

FIG. 12 is a diagrammatic representation of a process for making a thin film according to an embodiment of the present disclosure.

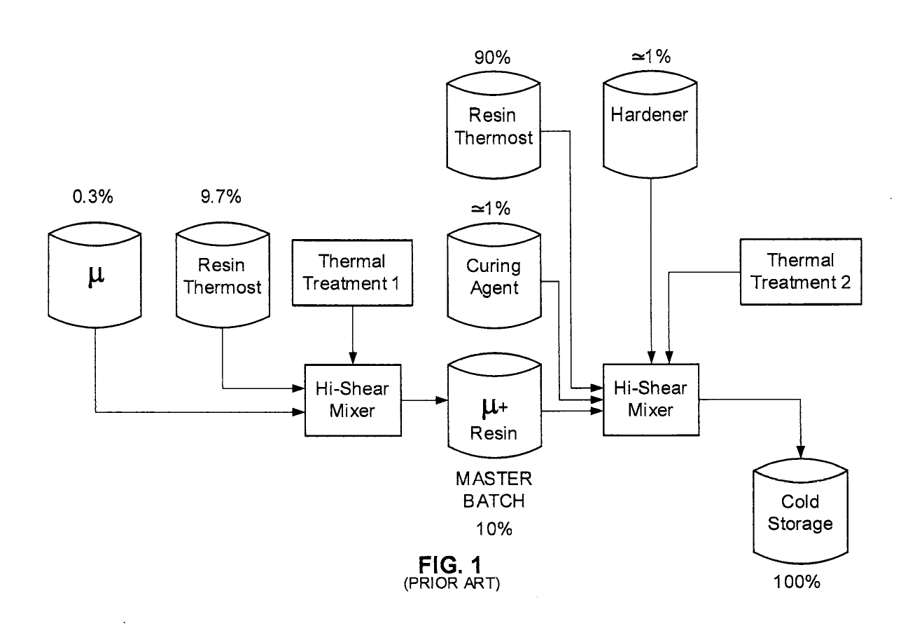

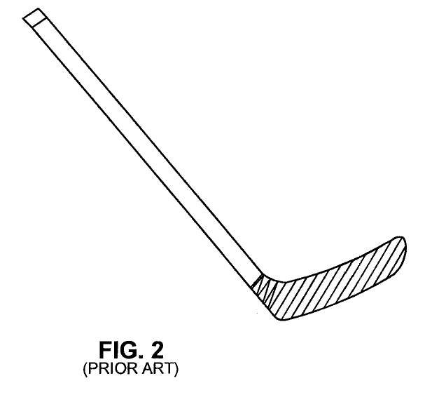

### DETAILED DESCRIPTION OF THE INVENTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

The following disclosure is generally directed to the inclusion of very small particles, often called “ultrafine” particles or “nanoparticles” terms used interchangeably within this disclosure along with the word “particle.” Particles can be added to a polymeric resin matrix to form a film, a prepreg, and reinforced components therewith. Within the scope of this disclosure, the terms “nanoparticle” “ultrafine particle” and even “particle” includes all commonly known definitions of this term and also includes other known nanostructures, such as, for example, nanoclusters, nanopowders, and nanocrystals of any suitable shape, including but not limited to nanospheres, nanorods, nanofibers, and nanocups. The term “nanoparticles” is also to be construed to include structures made of different types of materials, including but not limited to metal, dielectric material, semiconductive materials, quantum dots, glass, carbon, or any hybrid structure therewith. While a preferred embodiment the term “carbon nanotubes” is used, this term is used interchangeably with the term “nanoparticle” and is understood to be a genus of the species CNT.

In addition, the term “thermoset resin” is to be read broadly to include all commonly known definitions of this term, generally known as thermosetting plastics, including but not limited to polymer materials that irreversibly cure through heat, chemical reaction, or irradiation. While epoxy resin is given as a preferred embodiment for the matrix thermoset resin, other known thermosets, such as vulcanized rubber, phenolic resin, duroplast, urea-formaldehyde foam, melamine resin, polyamide, and mold are contemplated. While in a preferred embodiment the term “epoxy resin” is used, this term is used interchangeably with the broader term “thermoset resin” understood to be a genus of species epoxy resin.

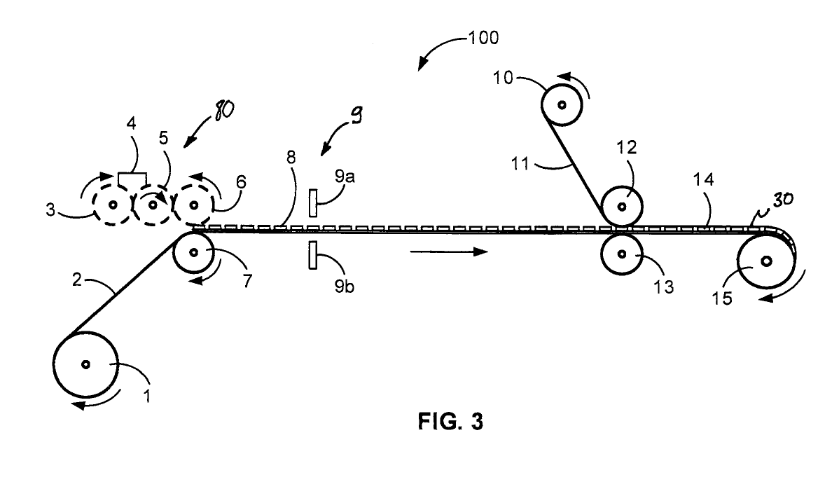

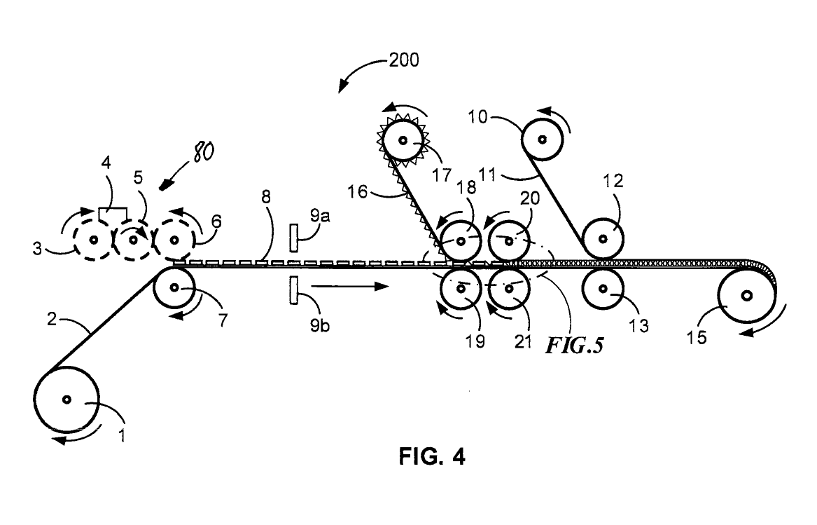

FIG. 3 shows a device 100 to produce a film 30 from a master batch used and introduced into the reservoir of a mixer 4, such as for example a hi-shear mixer. In a preferred embodiment, this master batch comprises CNTs mixed with thermoset resins. In one embodiment, approximately 3 wt % of CNTs is mixed with approximately 97 wt % of thermoset resin and additives to create an initial base, a product called R1D1 from the Nanoledge Incorporation, which is the master batch in this example, and from this master batch the final resin mixture is created when mixed with approximately 90 percent in mass (wt %) of the same or a different thermoset resins to dilute the initial content of CNTs from which a film or prepreg is obtained as shown on FIGS. 3 and 4.

In a preferred embodiment, the weight proportion of CNTs in the master batch is approximately 0.3 wt % of CNT. This proportion is designed to optimize mechanical properties such as strength and fracture toughness. Optimization of weight proportion is described in “Fabrication and Characterization of Carbon/Epoxy Composites Mixed with Multi-Walled Carbon Nanotubes,” Materials Science and Engineering, 475 (2008) 157-165, by Yuanxin Zhou, Farhana Pervin, Lance Lewis, and Shaik Jeelani.

While one weight proportion is described as a preferred embodiment, it is understood that specific properties are obtained based on the mechanical characteristics of the ultrafine particles and nanoparticles placed within the matrix. For example, CNTs are long tubes and create an effective network to strengthen the matrix at 0.3 wt % in an epoxy resin. Shorter nanoparticles may, for example, require a higher weight proportion to achieve optimal properties. While one weight proportion is given for CNTs in epoxy, what is contemplated is the use of any optimized weight proportion of nanoparticle in thermoset resin achieved simply by conducting a series of resistance tests at different weight proportions until an optimal strength is observed.

The final resin mixture may also be mixted with other generally known additives to alter the different properties of the resin mixture and the associated film, prepreg, and reinforced composite made therewith. For example, additives can include diaminodiphenyl sulfone (DDS), dicyandiamide (DICY), other amines to act as hardening agents, or curing agents that react under heat and change the characteristics of the composite, such as the curing temperature, the viscosity at room temperature, and the curing reaction temperature of the resin, for example when heated between 40° C. to 100° C. to liquefy the resin. In one preferred embodiment, drums are warmed up in the device 100 to approximately 60° C. to 95° C. The curing temperature of the resin mixture can be controlled by using additives to reach the optimal viscosity for the creation of a film. For example, using DICY, the curing point is decreased to approximately 90° C. to 95° C. which is closer to the liquefying point, whereas the use of anhydride increases the curing temperature to 125° C. to 130° C. and thus prevents partial curing during the liquefying process. In a preferred embodiment, the thermoset resin is made of more than a single type of epoxy.

In one of the preferred methods, processing the resin mixture includes the use of a three-roll mill. One such device is shown in FIGS. 3 and 4 where a reservoir 4 is placed over two counter-rotational rollers 3, 5 as indicated by the arrows. A ROSS® hi-shear mixer may be used for example. As shown schematically in FIGS. 3 and 4, the left roller 3 is a support structure and allows for a warmed resin mixture located in the reservoir 4 to spread evenly at the sheer interface between rollers 3 and 5. The middle roller 5, also known as the sheering roller, transfers a uniform thickness of the resin mixture onto the coating roller 6. A roll of release paper 1 made of a layer of paper 2 coated with a release agent or with any other nonstick surface, such as silicone, is then introduced between the coating roller 6 and the paper support roller 7 as a support for the in this manner obtained film made of the resin mixture. The paper can be, for example, an adhesive polymer film or a double-sided, non-adhesive, paper-based layer. In one preferred embodiment, the paper 2 is from the Loparex® Corporation.

FIG. 6 illustrates the paper 2 coated with a layer of a release agent 22 and a layer of resin 23. Returning to FIGS. 3 and 4, at a subsequent step, the film and the paper support, also called the composite film, pass at a measuring center 9, made in one embodiment of opposing lasers 9a, 9b as shown in FIGS. 3 and 4. The lasers measure the thickness of the film by comparing the summed distances between each laser head with the fixed distance between the lasers. In one embodiment, the thickness of the coating ranges from 1 mm to 0.05 mm. In a preferred embodiment, the film has a thickness of approximately 0.20 mm. In the process of creating a prepreg as shown in FIG. 4 and embodied in the cross-sectional views shown in FIGS. 7 and 8, a fiber reinforcement 16 having a linear weight of approximately 0.7 kg/m³ is merged into a resin 23 where the volume of both the resin and the reinforcement are approximately equal. Since the epoxy resin migrates between the fibers of the reinforcement 16, such as a tissue of carbon fibers, the linear weight of the prepreg is approximately 1.08 to 1.12 kg/m³ in a volume substantially identical to the volume of the resin 23. In another embodiment, a film can be made with two or more layers of resin mixtures, each made on a different mixer.

As shown in FIGS. 3 and 4, a second layer of paper 11 can be placed onto the film or the prepreg for long-term storage in a roll 15. FIG. 4 shows the intermediate stages of production associated with the creation of a prepreg. An additional step with support rollers 18, and 19, places the reinforcement 16 in proximate contact with the film as shown in greater detail in FIG. 7. In one embodiment a semipreg is prepared by placing the reinforcement 16 in contact with a heated and sticky layer of resin 23 as shown in FIG. 7. The semipreg is then used as would a prepreg with the exception that a pressure step must be performed at a later time when the semipreg is placed on a reinforced component. Returning to FIGS. 3 and 4, as the film and the reinforcement 16 move to a heating position next to pressure rollers 20, 21, the reinforcement 16 is fused into the film to create a prepreg.

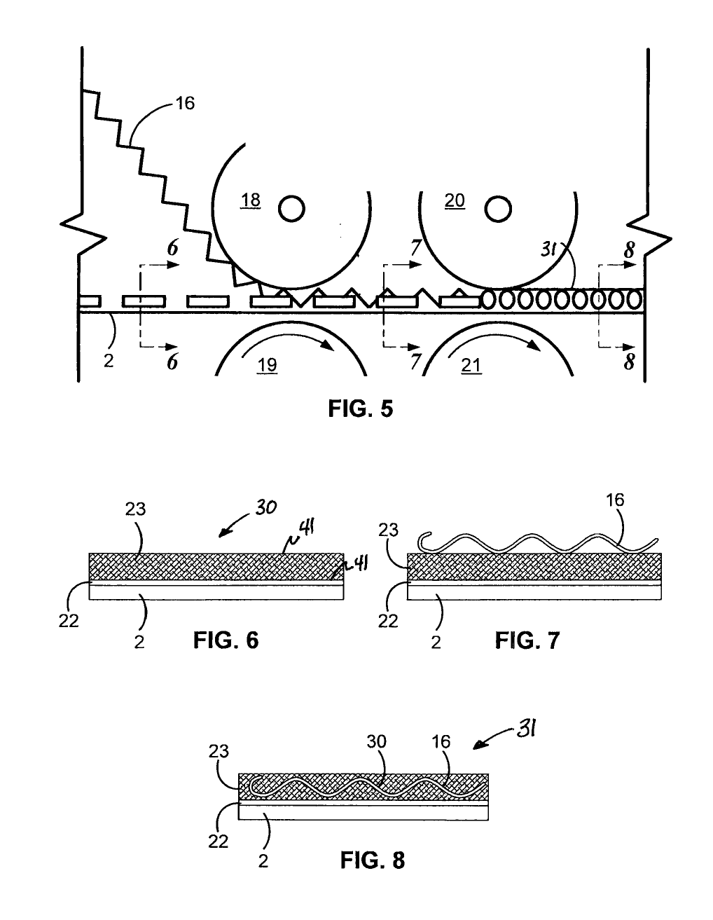

In one embodiment, successive layers of film and reinforcement are used in a sandwich-type structure to create a layered composite with a thickness given by the sum of the single layers. In another embodiment, a single layer of fiber reinforcement is placed in the middle of two opposite film layers to facilitate the migration of the film into the reinforcement structure. FIG. 5 illustrates how the fiber reinforcement 16 is progressively merged into the film 23 to form the prepreg 31.

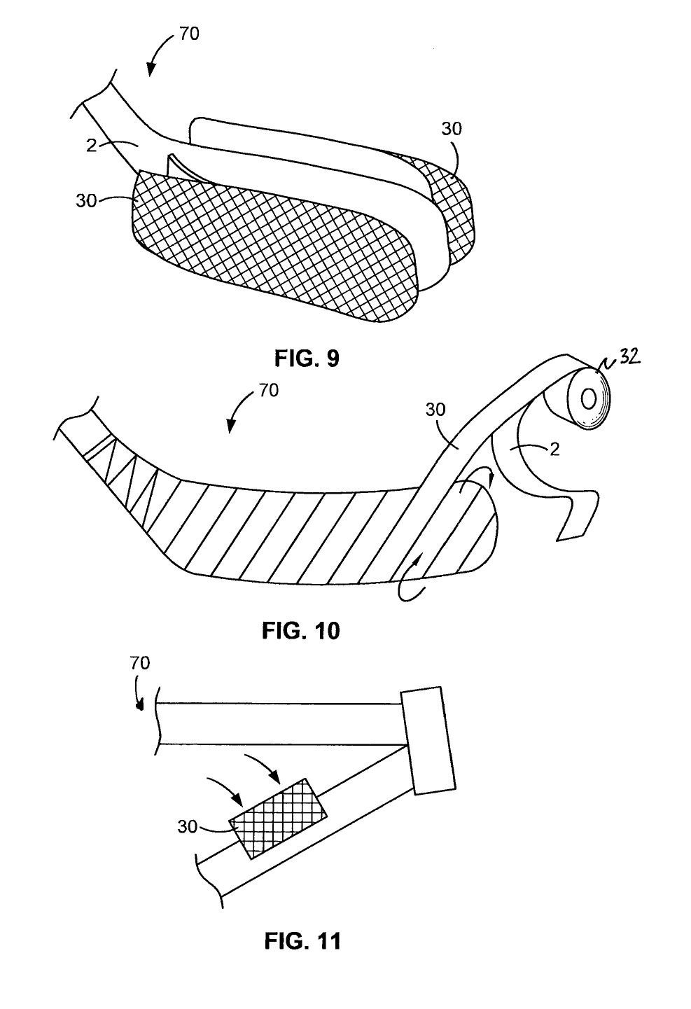

One advantage of the distribution of the resin mixture in form of a film is the capacity to remove heat and to cool the film rapidly to prevent heat-related shifts in the CNT network in the matrix. Another advantage of using a film is to facilitate the impregnation of a layer of fibers with the film to create a prepreg 31. Yet another advantage of a film-based structure is possibility to store the structure as a roll 15. Finally, FIGS. 9, 10, and 11 show three different possible reinforced components, such as, for example, a hockey stick 70 with a blade reinforced by the film or the prepreg made with the process described above where the film 30 or prepreg 31 is a sheet placed on the blade (FIG. 8), is in a roll of tape 32 wrapped around the blade and later cured (FIG. 9), or is on a bike frame (FIG. 10) with a patch 33 made of film 30 or prepreg 31 to reinforce the frame 70. While one method of creating a reinforced component using the film or prepreg is shown, any known method of creating a component using thermoset resin is contemplated.

A composite film 30 with a release layer 2 with at least a release side containing a release agent 22 is also contemplated. The laminated composite layer shown in FIG. 6 includes at least a thermoset resin mixture 23 acting as a support matrix for a quantity of dispersed nanoparticles. The laminated composite layer is releasably attached to the release layer 2 via the release agent 22. The laminated composite layer includes a first side 42 and a second side 41 in opposition wherein the release layer 2 is releasably attached to the first side 42.

In a further embodiment, a device for producing a composite film 100 includes a layer of release paper 2 unwound between an entry release paper roll 1 connected to a first holder and a final film roll 15 connect to a second holder. The device 100 also includes a mixer 80 with a reservoir 4 for holding a mixture made of a thermoset resin matrix and a quantity of dispersed nanoparticles, the mixer 80 includes a shear roller 5 for dispersing the resin mixture onto a coating roller 6. As shown in FIG. 4, a layer of fiber reinforcement 16 is unwound between an entry reinforcement material release roll 17 connected to a third holder where the final film roll 15 is connected to the second holder. The devices 100 and 200 for the creation of a film 30 and a prepreg 31, respectively, include a thickness detector 9 for measuring a thickness of the thin film 22 deposited onto the layer of release paper. The device 200 may also include thermal and pressure rollers 20, 21 for easier pressing the fiber reinforcement into the thin film as shown in FIG. 8.

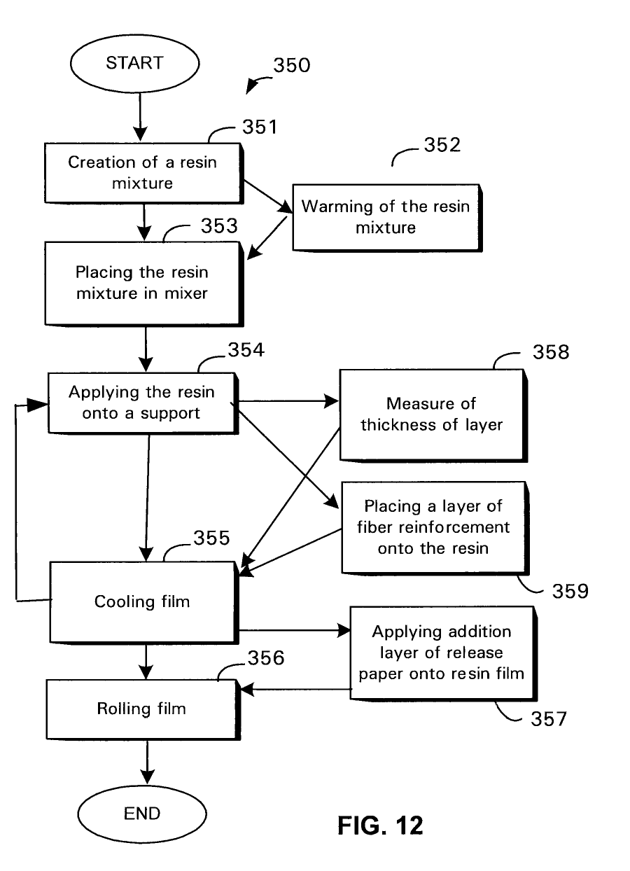

FIG. 12 as shown by FIGS. 3, and 4 also show a process 350 for making a thin film where a resin mixture is inserted into the mixer 80 and one or two release paper layers 2, 11 and a reinforcement layer 16 as shown on FIG. 4 are unrolled to form the final product, such as a thin film stored in roll 15. The process as shown in FIG. 12 includes the creation of a mixture 351 of thermoset resin and a quantity of dispersed nanoparticles therein, distributing the nanoparticles uniformly within the thermoset resin wherein the uniform distribution is at a specified weight distribution, and warming 352 of the resin mixture to lower the viscosity of the resin mixture. In one embodiment, the warming is conducted at the mixer 80.

The process also includes placing 353 the resin mixture into a mixer having a shear roller 5 and a coating roller 6 and releasably coating 354 a layer of resin mixture shown by the dashed line at coating roller 6 with a first side 42 and a second side 41 in opposition onto a release paper 2 to form a thin film 23. The release paper 2 is in contact with the first side 42 as shown in FIG. 6. Finally, the process includes cooling 355 the thin film before it is rolled 15 for storage. Cooling can be done using natural air venting, a rest period, or cold air.

In another embodiment, the second side 41 can be coated as shown at rolls 12, 13 of FIG. 3 by a second release paper layer 11 in contact 357 with the second side 41. The second layer, much like the first layer, can include a release agent, nonstick silicone, or other surface treatments. The release capacity of the first and the second layer may be different. In yet another embodiment, a step of measuring the thickness of the layer 358 is also contemplated, and a step of placing a layer of fiber reinforcement onto the resin is also contemplated.

The thin film is produced by a fabrication process similar to what is described above. The process includes taking a mixture of thermoset resin made of a quantity of dispersed nanoparticles at a certain weight distribution in the thermoset resin, warming the resin mixture, mixing the warmed resin mixture until the first weight distribution of nanoparticles is uniformly arranged in the matrix, coating a layer of master batch with a first side and a second side in opposition over a releasable paper layer to form a thin film, cooling the thin film to stabilize the distribution of nanoparticles in the layer, and rolling the thin film into a roll. Before the final step of rolling the thin film into a roll for storage, the process further comprises the step of releasably coating a second release paper layer in contact with the second side and releasably coating the layer and also releasably coating at least a second layer of master batch on the second side.

It is understood that the preceding detailed description of some examples and embodiments of the present invention may allow numerous changes to the disclosed embodiments in accordance with the disclosure made herein without departing from the spirit or scope of the invention. The preceding description, therefore, is not meant to limit the scope of the invention but to provide sufficient disclosure to one of ordinary skill in the art to practice the invention without undue burden.

What is claimed is:

1. A composite film, comprising:
a release layer with at least a release side; and
a laminated composite layer having at least a thermoset resin matrix acting as a support matrix for a dispersed quantity of particles, wherein the laminated composite layer is releasably attached to the release layer.

2. The composite film of claim 1, wherein the particle is a carbon nanotube (CNT) and the thermoset resin is at least an epoxy polymer.

3. The composite film of claim 2, wherein the epoxy polymer is a blend of at least two epoxy polymers.

4. The composite film of claim 1, wherein the thermoset resin matrix is a mixture of at least two epoxy polymers and a curing agent.

5. The composite film of claim 4, wherein the curing agent is selected from the group consisting of an amine and an anhydride.

6. The composite film of claim 4, wherein the mixture further comprises a thermoplastic polymer.

7. The composite film of claim 1, wherein the particles is a CNT and the quantity of dispersed nanoparticles is approximately 0.3 wt %.

8. The composite film of claim 1, further comprising a layer of fiber reinforcement within the laminated composite layer.

9. The composite film of claim 8, wherein the fiber reinforcement is selected from the group consisting of carbon fibers or glass fibers.

10. The composite film of claim 1, wherein the laminated composite layer includes a first side and a second side in opposition, wherein the release layer is releasably attached to the first side, and wherein the composite film further comprises a second release layer with at least a second release side releasably attached to the second side.

11. The composite film of claim 1, wherein the laminated composite layer is comprised of at least two successive laminated layers of thermoset resin matrix.

12. A device for producing a composite film, comprising:
an entry release paper roll connected to a first holder and a final film roll connect to a second holder;
a layer of release paper unwound and held by the first and second holders;
a mixer with a reservoir containing a mixture made of a thermoset resin matrix and a quantity of dispersed particles, the mixer including a shear roller for dispersing a master batch resin onto a coating roller, and wherein the coating roller in turn dispenses a thin film onto the layer of release paper.

13. The device for producing a composite film of claim 12, wherein the particles are CNTs and the thermoset resin is at least an epoxy polymer.

14. The device for producing a composite film of claim 13, wherein the epoxy polymer is a blend of at least two epoxy polymers.

15. The device for producing a composite film of claim 12, wherein the thermoset resin matrix is a mixture of at least two epoxy polymers and a curing agent.

16. The device for producing a composite film of claim 15, wherein the curing agent is selected from the group consisting of an amine and an anhydride.

17. The device for producing a composite film of claim 15, wherein the mixture further comprises a thermoplastic polymer.

18. The device for producing a composite film of claim 12, wherein the particles are CNTs and the quantity of dispersed nanoparticles is approximately 0.3 wt %.

19. The device for producing a composite film of claim 12, further comprising a third holder, wherein a layer of fiber reinforcement is unwound between an entry reinforcement release roll connected to the third holder and the final film roll connected to the second holder.

20. The device for producing a composite film of claim 12, further comprising a thickness detector for measuring a thickness of the thin film deposited onto the layer of release paper.

21. The device for producing a composite film of claim 19, further comprising a thermal roller and a pressure roller for merging the fiber reinforcement into the thin film.

22. The device for producing a composite film of claim 19, wherein the fiber reinforcement is selected from a group consisting of a carbon fiber reinforcement and a glass fiber reinforcement.

23. The device for producing a composite film of claim 19, wherein the thin film includes a first side and a second side in opposition, wherein the thin film is deposited onto the layer at the first side, and wherein the device further comprises a second layer of release paper unwound between a second entry release paper roll connected to a fourth holder and the final film roll connected to the second holder, and wherein the second layer of release paper is releasably attached to the second side.

24. The device for producing a composite film of claim 23, wherein a reinforcement layer is adhesively connected to the second side.

25. A process for making a thin film, comprising:
creating a mixture of a polymer, a curing agent and a quantity of dispersed particles therein at a uniform distribution of the particles within the thermoset resin;
placing the mixture into a mixer with a shear roller and a coating roller;
releasably coating a layer of the mixture with a first side and a second side in opposition onto a release paper to form a thin film, wherein the release paper is in contact with the first side;
cooling the thin film; and
rolling the thin film into a roll for storage.

26. The process for making a thin film of claim 25, further comprising warming the mixture to lower a viscosity of the mixture.

27. The process for making a thin film of claim 25, further comprising releasably coating a second release paper layer in contact with the second side.

28. The process for making a thin film of claim 25, further comprising coating at least a second layer of master batch on the second side.

29. The process of making a thin film of claim 25, further comprising measuring a thickness of the layer using a measuring means.

30. A thin film produced by a process of making thereof, the process comprising:
creating a mixture of a polymer, a curing agent, and a quantity of dispersed particles therein at a uniform distribution of the particles within the mixture;
placing the mixture into a mixer with a shear roller and a coating roller;
releasably coating a layer of the mixture with a first side and a second side in opposition onto a release paper to form a thin film, wherein the release paper is in contact with the first side;
cooling the thin film; and
rolling the thin film into a roll for storage.

31. The thin film produced by a process for making of claim 25, further comprising warming the mixture to lower a viscosity of the mixture.

32. The thin film produced by a process for making of claim 30, wherein the process further comprises releasably coating a second release paper layer in contact with the second side.

33. The thin film produced by a process for making of claim 30, wherein the process further comprises adhesively connecting at least a fiber reinforcement on the second side.

34. The thin film produced by a process of making of claim 30, wherein the process further comprises coating at least a second layer of the mixture on the second side.

35. A reinforced component, comprising:
a component having a surface, and
a laminated composite layer having at least a thermoset resin matrix serving as a support matrix for a dispersed quantity of nanoparticles, wherein the laminated composite layer is cured on the surface of the component.

36. The reinforced component of claim 35, wherein the particle is a CNT and the thermoset resin is at least an epoxy polymer.

37. The reinforced component of claim 36, wherein the epoxy polymer is a blend of at least two epoxy polymers.

38. The composite film of claim 36, wherein the thermoset resin matrix is a mixture of at least two epoxy polymers and a curing agent.

39. The composite film of claim 38, wherein the curing agent is selected from the group consisting of an amine and an anhydride.

40. The composite film of claim 38, wherein the mixture further comprises a thermoplastic polymer.

41. The reinforced component of claim 35, wherein the particles is a CNT and the quantity of dispersed particles is approximately 0.3 wt %.

42. The reinforced component of claim 35, wherein the laminated composite layer further comprises a fiber reinforcement within the laminated composite layer prior to a cure of the reinforced component.

43. The reinforced component of claim 35, wherein the fiber reinforcement is selected from the group consisting of carbon fibers or glass fibers.

44. A method of producing a composite film, comprising:
manufacturing a release layer with at least a release side; and
laminating a composite layer having at least a polymer matrix acting as a support matrix for a dispersed quantity of particles, and a curing agent, wherein the composite layer is releasably attached to the release layer.
